(19) United States
(12) Patent Application Publication
(10) Pub. No.: US 2016/0013976 A1
(43) Pub. Date: Jan. 14, 2016

(54) Wireless Through Link Traffic Reduction

(71) Applicant: Futurewei Technologies, Inc., Plano, TX (US)

(72) Inventor: Donald E. Eastlake, III, Milford, MA (US)

(21) Appl. No.: 14/798,904

(22) Filed: Jul. 14, 2015

Related U.S. Application Data
(60) Provisional application No. 62/024,350, filed on Jul. 14, 2014.

(51) Int. Cl. H04L 12/24; H04W 28/12

(52) U.S. Cl. CPC H04L 41/0806; H04W 28/12

(57) ABSTRACT

A network configuring method that includes receiving a first message at a first station from a second station that indicates message types that are not accepted by the second station, receiving a data packet, determining a message type for the data packet, discarding the data packet when the message type is not accepted by the second station, and forwarding the data packet when the message type is accepted by the second station. A network device that includes a transmitter, a receiver, a memory, and a processor configured to receive a first message from a station that indicates message types that are not accepted by the station, receive a data packet, determine a message type for the data packet, discard the data packet when the message type is not accepted by the station, and forward the data packet when the message type is accepted by the station.

### CROSS-REFERENCE TO RELATED APPLICATIONS

The present application claims benefit of U.S. Provisional Patent Application No. 62/024,350 filed Jul. 14, 2014 by Donald Eastlake and entitled “Traffic Reduction for Wireless Through Links,” which is incorporated herein by reference as if reproduced in its entirety.

### STATEMENT REGARDING FEDERALLY SPONSORED RESEARCH OR DEVELOPMENT

Not applicable.

### REFERENCE TO A MICROFICHE APPENDIX

Not applicable.

### BACKGROUND

The Institute of Electrical and Electronics Engineers (IEEE) 802.11ak project is extending 802.11 (Wi-Fi) links so that they can be used as transit links in bridged 802.1Q virtual local area network (VLAN) aware networks. In wired bridge networks, unicast traffic to an unknown destination is flooded using multi-destination frames within a VLAN as broadcast traffic. Other multi-destination traffic such as multicast traffic may also be flooded through portions of a network. It may be common for the network at one end of an 802.11ak link to be a subnet where all the stations are known and all multicast groups of interest are known. If such a network is a stub subnet, then signaling the network wastes air time when flooded traffic is not be of interest to the subnet.

Existing systems declare interest in certain VLANs so that traffic in other VLANs is not sent. Other existing systems declare interest in certain media access control (MAC) addresses. Such existing system provide ways to limit the distribution of traffic for known VLANs and MACs, but for dynamic networks the traffic to unknown individually addressed MAC addresses is still flooded on a link to discover if the addressed station is down that link. It is desirable to limit the distribution of traffic for both known and unknown addresses.

### SUMMARY

In one embodiment, the disclosure includes a network configuring method comprising receiving a first message at a first station from a second station that indicates message types that are not accepted by the second station, receiving a data packet, determining a message type for the data packet, discarding the data packet when the message type is not accepted by the second station, and forwarding the data packet when the message type is accepted by the second station.

In another embodiment, the disclosure includes a network device comprising a transmitter, a receiver, a memory, and a processor coupled to the transmitter, receiver, and memory, and configured to receive a first message from a station that indicates message types that are not accepted by the station, receive a data packet, determine a message type for the data packet, discard the data packet when the message type is not accepted by the station, and forward the data packet when the message type is accepted by the station.

In yet another embodiment, the disclosure includes a network configuring method comprising sending a first message from a first station to a second station that indicates message types that are not accepted by the first station, and receiving a second message that indicates message types that are not accepted by the second station in response to the first message.

These and other features will be more clearly understood from the following detailed description taken in conjunction with the accompanying drawings and claims.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIG. 1 is a schematic diagram of a network for communicating wireless data traffic.

FIG. 2 is a schematic diagram of an embodiment of a network element.

FIG. 3 is a protocol diagram of an embodiment of a network configuring method.

FIG. 4 is a flowchart of an embodiment of a network configuring method.

FIG. 5 is a flowchart of another embodiment of a network configuring method.

FIG. 6 is an embodiment of a general link capabilities information element.

### DETAILED DESCRIPTION

It should be understood at the outset that although an illustrative implementation of one or more embodiments are provided below, the disclosed systems and/or methods may be implemented using any number of techniques, whether currently known or in existence. The disclosure should in no way be limited to the illustrative implementations, drawings, and techniques illustrated below, including the exemplary designs and implementations illustrated and described herein, but may be modified within the scope of the appended claims along with their full scope of equivalents.

Disclosed herein are various embodiments for limiting the distribution of traffic for both known and unknown addresses. Data traffic is not sent over a wireless link unless the station at the other end of the link has expressed interest in a MAC address, VLAN, or the like. For example, a station may request that unknown individually addressed or group addressed data traffic is flooded to it within certain specified VLANs or all VLANs. Stations are configured to indicate MAC addresses or VLANs that they are interested in and to add or remove MAC addresses and VLANs that they are interested in. A station may indicate its interest in MAC addresses or VLANs at connection set up time or during the connection protocol. Stations are also capable of changing policies about flooding for various traffic types such as broadcast traffic, unknown destination unicast traffic, and unrequested multicast group traffic. Signaling the network that multicast, broadcast, or flooded unknown unicast traffic is not of interest may save air time.

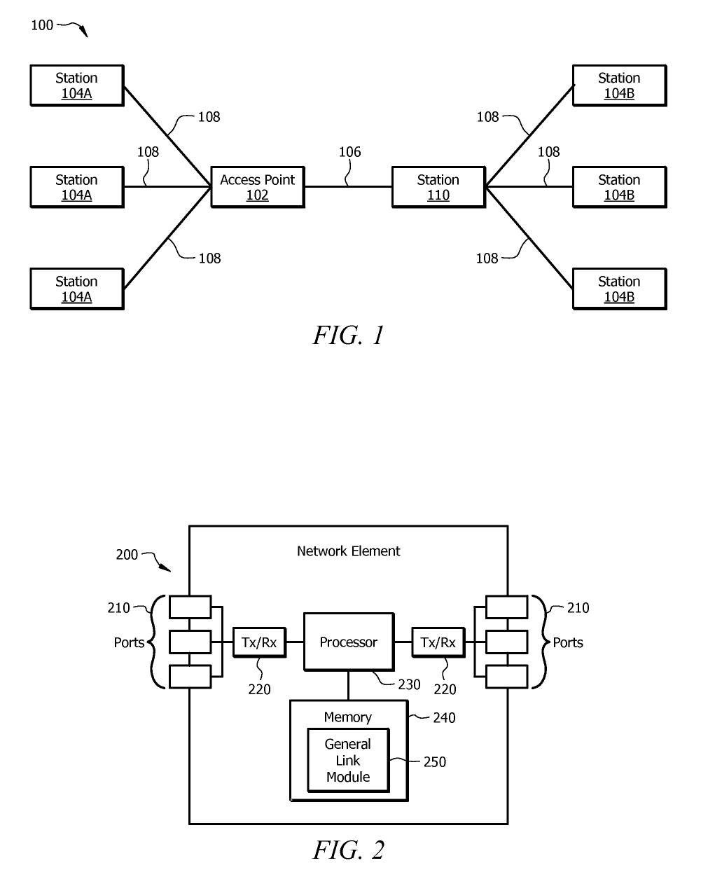

FIG. 1 is a schematic diagram of a network 100 for communicating wireless data traffic. Network 100 comprises access points 102 and non-access point stations 110, 104A, and 104B. Access point 102 is configured to provide access for communicating data traffic and distributing services for stations 110, 104A, and 104B. Access point 102 is in data communication with station 110 using a wireless link or connection 106. For example, access point 102 is in data communication with station 110 using an IEEE 802.11ak link. Additional details about an IEEE 802.11ak link are described in IEEE standard draft titled, “Part 11: Wireless LAN Medium Access Control (MAC) and Physical Layer (PHY) Specifications—Amendment 4: Enhancements For Transit Links Within Bridged Networks,” published in April 2015, which is hereby incorporated by reference as if reproduced in its entirety. Alternatively, access point 102 may be in data communication station 110 using any other suitable type of connection or link as would be appreciated by one of ordinary skill in the art upon viewing this disclosure. Access point 102 is also coupled to and in signal communication with stations 104A using wired or wireless links 108. Station 110 is coupled to and in signal communication with stations 104B using wired or wireless links 108. Stations 110, 104A, and 104B are addressable network devices. Additional details about access point 102 and stations 110, 104A, and 104B are described in IEEE standard draft titled, “Part 11: Wireless LAN Medium Access Control (MAC) and Physical Layer (PHY) Specifications,” published in January 2015, which is hereby incorporated by reference as if reproduced in its entirety.

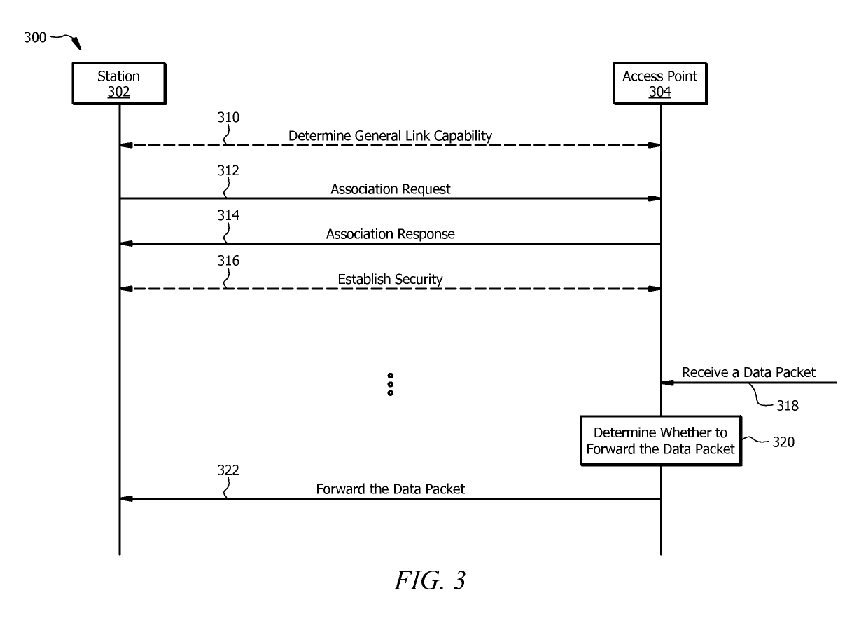

FIG. 2 is a schematic diagram of an embodiment of a network element 200. The network element 200 may be suitable for implementing the disclosed embodiments. Network element 200 may be any device (e.g., a station, an access point, a modem, a switch, router, bridge, server, client, controller, etc.) that transports or assists with transporting data through a network, system, and/or domain. For example, network element 200 may be implemented in stations 110, 104A, and 104B and access point 102 in FIG. 1 or in station 302 and access point 304 in FIG. 3. Network element 200 comprises ports 210, transceiver units (Tx/Rx) 220, a processor 230, and a memory 240 comprising a general link module 250. Ports 210 are coupled to Tx/Rx 220, which may be transmitters, receivers, or combinations thereof. The Tx/Rx 220 may transmit and receive data via the ports 210. Processor 230 is configured to process data. Memory 240 is configured to store data and instructions for implementing embodiments described herein. The network element 200 may also comprise electrical-to-optical (EO) components and optical-to-electrical (OE) components coupled to the ports 210 and Tx/Rx 220 for receiving and transmitting electrical signals and optical signals.

The processor 230 may be implemented by hardware and software. The processor 230 may be implemented as one or more central processing unit (CPU) chips, logic units, cores (e.g., as a multi-core processor), field-programmable gate arrays (FPGAs), application specific integrated circuits (ASICs), and digital signal processors (DSPs). The processor 230 is in communication with the ports 210, Tx/Rx 220, and memory 240.

The memory 240 comprises one or more of disks, tape drives, or solid-state drives and may be used as an over-flow data storage device, to store programs when such programs are selected for execution, and to store instructions and data that are read during program execution. The memory 240 may be volatile and non-volatile and may be read-only memory (ROM), random-access memory (RAM), ternary content-addressable memory (TCAM), and static random-access memory (SRAM). General link module 250 is implemented by processor 230 to execute the instructions for limiting the distribution of traffic for both known and unknown addresses by identifying certain types of data traffic that are not accepted or that are not of interest to a station or access point and forwarding or discarding data packets based on the message type of the data packet. The inclusion of general link module 250 provides an improvement to the functionality of network element 200. General link module 250 also effects a transformation of network element 200 to a different state. Alternatively, general link module 250 is implemented as instructions stored in the processor 230.

FIG. 3 is a protocol diagram 300 of an embodiment of a network configuring method. The network configuring method is implemented to limit the distribution of traffic for both known and unknown addresses by identifying certain types of messages that are not accepted by or that are not of interest to stations 302 and/or access point 304 and forwarding or discarding data packets based on the message type of the data packet. Station 302 may be configured similarly to station 110, 104A, and 104B and access point 304 may be configured similarly to access point 102 in FIG. 1. In another embodiment, access point 304 may be substituted with another station.

At step 310, station 302 and access point 304 determine whether general link capabilities are supported. In an embodiment, station 302 sends a general link capabilities information element in a beacon broadcast to access point 304 to determine whether general link capabilities are supported. Alternatively, station 302 sends a probe message that comprises the general link capabilities information element and identifies access point 304. Access point 304 may send a response message that indicates general link capabilities are supported. In an embodiment, step 310 may be optional and may be omitted.

The presence of a general link capabilities information element in certain types of messages indicates that general link capabilities are supported. For example, the general link capabilities information element may be found within an association request message, an association response message, a mesh peering open message, a mesh peering confirm message, a TDLS request message, a TDLS response message, a beacon message, a probe request, a probe response, a directional multi-gigabit (DMG) beacon message, or any other suitable message as would be appreciated by one of ordinary skill in the art upon viewing this disclosure. The general link capabilities information element may be configured similar to general link capabilities information element 600 described in FIG. 6. Additional details for a general link capabilities information element, an association request message, an association response message, a mesh peering open message, a mesh peering confirm message, a TDLS request message, a TDLS response message, a beacon message, a probe request, a probe response, and a DMG beacon message are described in IEEE standard draft titled, “Part 11: Wireless LAN Medium Access Control (MAC) and Physical Layer (PHY) Specifications—Amendment 4: Enhancements For Transit Links Within Bridged Networks,” published in April 2015.

At step 312, station 302 sends an association request message that comprises a general link capabilities information element which indicates message types that are not accepted by station 302. The association request message indicates one or more message types that are not accepted by or of interest to station 302. Alternatively, station 302 may indicate message types that are not accepted by station 302 using a mesh peering open message, a tunnel direct link setup (TDLS) request message, or any other suitable message as would be appreciated by one of ordinary skill in the art upon viewing this disclosure.

At step 314, access point 304 sends an association response message that comprises a general link capabilities information element which indicates message types that are not accepted by access point 304. The association response message indicates one or more message types that are not accepted by or of interest to access point 304. Alternatively, access point 304 may indicate message types that are not accepted by access point 304 using a mesh peering confirm message, a TDLS response message, or any other suitable message as would be appreciated by one of ordinary skill in the art upon viewing this disclosure. In an embodiment, access point 304 may not indicate message types that are not accepted when access point 304 accepts all message types.

Optionally at step 316, station 302 and access point 304 may implement a security protocol to secure the link between station 302 and access point 304. Any suitable security protocol may be implemented as would be appreciated by one of ordinary skill in the art upon viewing this disclosure.

At step 318, access point 304 receives a data packet. At step 320, access point 304 determines whether to send the data packet to station 302. Access point 304 determines a message type for the data packet and discards the data packet when the message type of the data packet is not accepted by station 302; otherwise, access point 304 proceeds to step 322. At step 322, access point 304 forwards the data packet to station 302 based on the determination. Steps 318-322 may be repeated as access point 304 receives data packets.

In an embodiment, the network configuring method is symmetric and station 302 also receives information about the message types that access point 304 does not accept or does not want to receive. Station 302 will similarly make determinations based on the message type of data packets and the accepted message types that are indicated by the access point 304 in a general link capabilities information element whether forward data packets or to discard data packets. Alternatively, the network configuring method is not symmetric and either the station 302 or the access point 304 make determinations based on the message type of data packets and the accepted message types whether to forward data packets or to discard data packets.

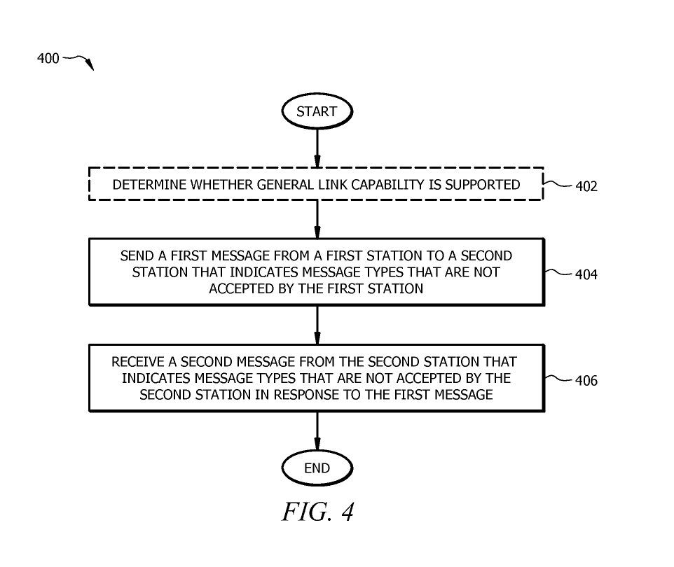

FIG. 4 is a flowchart of an embodiment of a network configuring method 400. Method 400 may be implemented by a station or an access point for limiting the distribution of traffic for both known and unknown addresses by rejecting certain types of data traffic. For example, method 400 may be implemented by a station to reduce data traffic by indicating message types that are not accepted or that are not of interest to the station. A station may be configured similarly to stations 110, 104A, and 104B in FIG. 1 or station 302 in FIG. 3 and an access point may be configured similarly to access point 102 in FIG. 1 or access point 304 in FIG. 3.

At step 402, the station determines whether general link capabilities are supported. The station may send a general link capabilities information element in a beacon broadcast from a first access point to a second station to determine whether general link capabilities are supported. Alternatively, the station may send a probe message that comprises the general link capabilities information element and identifies the second access point. The station may receive a response message that indicates that general link capabilities are supported from the second access point and/or the second station. The process of determining whether general link capabilities are support may be similar to the process described in step 310 in FIG. 3. In an embodiment, step 402 may be optional and may be omitted.

At step 404, the station sends a first message to a second station that indicates message types that are not accepted by the station. The first message may be an association request, a mesh peering open message, a TDLS request message, or any other suitable message as would be appreciated by one of ordinary skill in the art upon viewing this disclosure. Sending the first message to the second station may be similar to step 312 in FIG. 3.

At step 406, the station receives a second message from the second station that indicates message types that are not accepted by the second station in response to the first message. The second message may be an association response message, a mesh peering confirm message, a TDLS response message, or any other suitable message as would be appreciated by one of ordinary skill in the art upon viewing this disclosure. Receiving the second message from the second station that indicates message types that are not accepted by the second station may be similar to step 314 in FIG. 3.

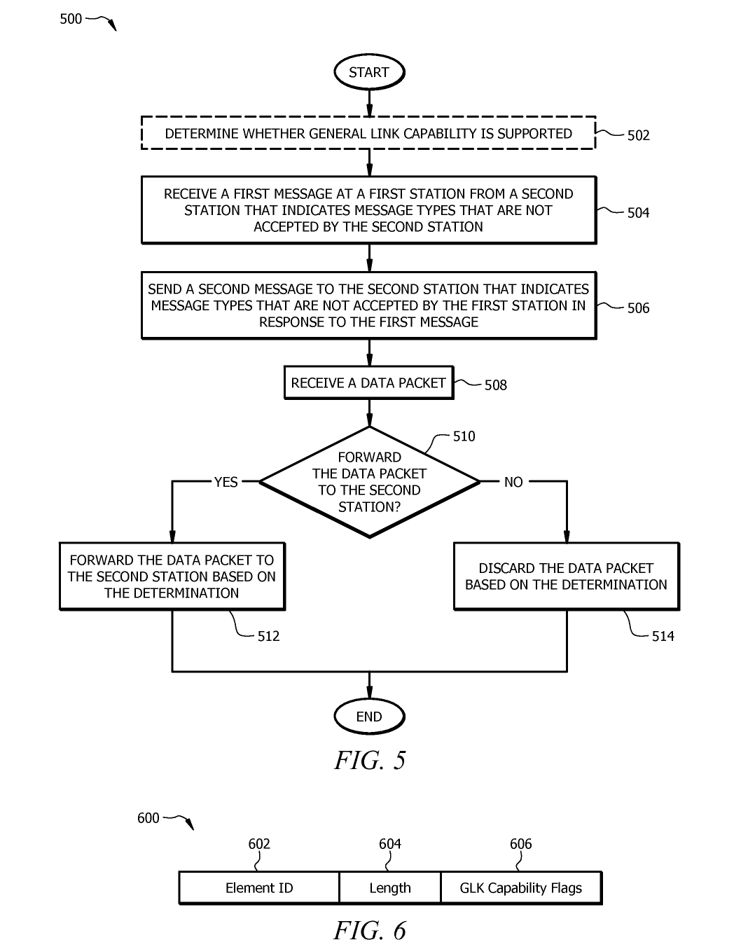

FIG. 5 is a flowchart of another embodiment of a network configuring method 500. Method 500 may be implemented by a station or an access point for limiting the distribution of traffic for both known and unknown addresses by rejecting certain types of data traffic. For example, method 500 may be implemented by a first station to reduce data traffic by discarding message types that are not accepted or that are not of interest to the first station. A first station may be configured similarly to stations 110, 104A, and 104B in FIG. 1 or station 302 in FIG. 3 and an access point may be configured similarly to access point 102 in FIG. 1 or access point 304 in FIG. 3.

At step 502, the first station determines whether general link capabilities are supported. The first station may send a general link capabilities information element in a beacon broadcast from a first access point to second access point and/or a second station to determine whether general link capabilities are supported. Alternatively, the first station may send a probe message that comprises the general link capabilities information element and identifies the second access point. The first station may receive a response message that indicates that general link capabilities are supported from the second access point and/or the second station. The process of determining whether general link capabilities are support may be similar to the process described in step 310 in FIG. 3. In an embodiment, step 502 may be optional and may be omitted.

At step 504, the first station receives a first message that indicates message types that are not accepted by a second station from the second station. The first message may be an association request, a mesh peering open message, a TDLS request message, or any other suitable message as would be appreciated by one of ordinary skill in the art upon viewing this disclosure. Receiving the first message that indicates message types that are not accepted by the second station may be similar to step 312 in FIG. 3.

At step 506, the first station sends a second message to the second station that indicates message types that are not accepted by the first station. The second message may be an association response message, a mesh peering confirm message, a TDLS response message, or any other suitable message as would be appreciated by one of ordinary skill in the art upon viewing this disclosure. Sending the second message to the second station that indicates message types that are not accepted by the station may be similar to step 314 in FIG. 3. In an embodiment, step 506 may be omitted.

At step 508, the first station receives a data packet. Receiving a data packet may be similar to step 318 in FIG. 3. At step 510, the first station determines whether to forward the data packet to the second station based on the message type of the data packet. The first station proceeds to step 514 when the message type of the data packet is not accepted by the second station; otherwise the first station proceeds to step 512. Determining whether to forward the data packet may be similar to step 320 in FIG. 3. At step 512, the first station forwards the data packet to the second station based on the determination. Forwarding the data packet to the second station may be similar to the process described in step 322 in FIG. 3.

Returning to step 510, the first station proceeds to step 514 when the message type of the data packet is not accepted by the second station. At step 514, the first station discards the data packet based on the determination.

FIG. 6 is an embodiment of a general link capabilities information element 600. A general link capabilities information element 600 indicates whether general link capabilities are supported. A general link capabilities information element 600 may be sent by a station or an access point within an association request message, an association response message, a mesh peering open message, a mesh peering confirm message, a TDLS request message, a TDLS response message, a beacon message, a probe request, a probe response, a DMG beacon message, or any other suitable message as would be appreciated by one of ordinary skill in the art upon viewing this disclosure. A station may be configured similarly to stations 110, 104A, and 104B in FIG. 1 or station 302 in FIG. 3 and an access point may be configured similarly to access point 102 in FIG. 1 or access point 304 in FIG. 3.

General link capabilities information element 600 comprises an element identifier (ID) field 602, a length field 604, and a general link (GLK) capabilities flags field 606. General link capabilities information element 600 may be configured as shown or in any other suitable configuration. Element ID field 602 is an identifier that is associated with the general link capabilities information element 600. Length field 604 may indicate the length of the general link capabilities information element 600, for example, in bytes. GLK capabilities flags field 606 comprises flag bits that indicate message types that are not accepted or are not of interest to a station and that should not to be sent to the station. For example, the general link capabilities information element 600 may comprise a first flag bit that when set indicates to not send broadcast data traffic, a second flag bit that when set indicates to not send flooded unknown destination unicast data traffic, and a third flag bit that when set indicates to not send unrequested multicast data traffic. The GLK capabilities flags field 606 may be configured with any combination of flag bits set. The combination of flag bits that are set may vary based on the circumstances and goals of a network operator. The GLK capabilities flags field 606 may be reconfigured, for example, through a re-association or other network control processes. The GLK capabilities flags field 606 may be reconfigured as circumstances and goals of a network operator change. Alternatively, general link capabilities information element 600 may comprise other flag bits that when set indicate to not send other types of data traffic or that indicate other GLK relevant station capabilities or configurations.

While several embodiments have been provided in the present disclosure, it should be understood that the disclosed systems and methods might be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

In addition, techniques, systems, subsystems, and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component whether electrically, mechanically, or otherwise. Other examples of changes, substitutions, and alterations are ascertainable by one skilled in the art and could be made without departing from the spirit and scope disclosed herein.

What is claimed is:

1. A network configuring method comprising:
receiving a first message at a first station from a second station that indicates message types that are not accepted by the second station;
receiving a data packet;
determining a message type for the data packet;
discarding the data packet when the message type is not accepted by the second station; and
forwarding the data packet when the message type is accepted by the second station.

2. The method of claim 1, further comprising sending a second message to the second station that indicates message types that are not accepted by the first station.

3. The method of claim 1, further comprising determining whether general link capabilities are supported.

4. The method of claim 1, wherein the first message indicates that broadcast traffic is not accepted.

5. The method of claim 1, wherein the first message indicates that unknown destination unicast traffic is not accepted.

6. The method of claim 1, wherein the first message indicates that unrequested multicast traffic is not accepted.

7. The method of claim 1, wherein the first message comprises flag bits that indicate the message types that are not accepted by the second station.

8. A network device comprising:
a transmitter configured to transmit a data packet;
a receiver configured to receive the data packet and a first message from a station that indicates message types that are not accepted by the station;
a memory; and
a processor coupled to the transmitter, receiver, and memory, and configured to:
determine a message type for the data packet;
discard the data packet when the message type is not accepted by the station; and
forward the data packet when the message type is accepted by the station.

9. The network device of claim 8, wherein the processor is configured to send a second message to the station that indicates message types that are not accepted by the network device.

10. The network device of claim 8, wherein the processor is configured to determine whether general link capabilities are supported.

11. The network device of claim 8, wherein the first message indicates that broadcast traffic is not accepted.

12. The network device of claim 8, wherein the first message indicates that unknown destination unicast traffic is not accepted.

13. The network device of claim 8, wherein the first message indicates that unrequested multicast traffic is not accepted.

14. The network device of claim 8, wherein the first message comprises flag bits that indicate the message types that are not accepted by the station.

15. A network configuring method comprising:
sending a first message from a first station to a second station that indicates message types that are not accepted by the first station; and
receiving a second message that indicates message types that are not accepted by the second station in response to the first message.

16. The method of claim 15, further comprising determining whether general link capabilities are supported.

17. The method of claim 15, wherein the first message indicates that broadcast traffic is not accepted.

18. The method of claim 15, wherein the first message indicates that unknown destination unicast traffic is not accepted.

19. The method of claim 15, wherein the first message indicates that unrequested multicast traffic is not accepted.

20. The method of claim 15, wherein the first message comprises flag bits that indicate the message types that are not accepted by the second station.
